(19) United States
(12) Patent Application Publication
(10) Pub. No.: US 2009/0313117 A1
(43) Pub. Date: Dec. 17, 2009

(54) TARGETED ADVERTISING

(75) Inventor: Xian Xiang Hu, San Jose, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/140,159

(22) Filed: Jun. 16, 2008

(51) Int. Cl. G06Q 30/00; G06Q 99/00

(52) U.S. Cl. 705/14.49

(57) ABSTRACT

Embodiments of methods, systems or devices for enabling targeted advertising of goods and services are disclosed.

### FIELD

The subject matter disclosed herein relates to techniques for enabling targeted advertising of goods and services.

### BACKGROUND

As technology associated with the use of computers, cell phones, computing devices or the like continues to change and also becomes more ubiquitous, advertising messages may at times be diluted due at least in part to the manner in which consumers may be inundated with more and more advertising through various forms of electronic media. Therefore, a need continues to exist for mechanisms that permit advertising to be targeted to particular consumers so that the message is less likely to be lost among the other advertising messages being delivered.

### DESCRIPTION OF THE FIGURES

Non-limiting and non-exhaustive embodiments will be described with reference to the following figures, wherein like reference numerals refer to like parts throughout the various figures unless otherwise specified.

FIG. 1 is a schematic diagram of an example embodiment of a client device;

FIG. 2 is a schematic diagram of an embodiment of a system for providing advertisements from a content provider;

FIG. 3 is a schematic diagram of a layout of a browser window according to an embodiment;

FIG. 4 is a schematic diagram of an Internet search system according to an embodiment;

FIG. 5 is a schematic diagram of an Internet search system according to an alternative embodiment;

FIG. 6 is a schematic diagram of an Internet search system according to yet another alternative embodiment;

FIG. 7 is a depiction of a browser window comprising partially-loaded landing page overlaid with targeted advertising information according to an embodiment;

FIG. 8A is a depiction of a browser window displaying a search results page according to an embodiment;

FIG. 8B is a depiction of a browser window displaying a partially loaded landing page overlaid with targeted advertising information according to an embodiment;

FIG. 8C is a depiction of a browser window displaying a partially loaded landing page overlaid with targeted advertising information according to yet another embodiment; and

FIG. 9 is a schematic diagram illustrating an Internet instant messaging system according to an embodiment.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

In this context, the terms, “and,” “or,” and “and/or” as used herein may include a variety of meanings that will depend at least in part upon the context in which used. Typically, “or” as well as “and/or” if used to associate a list, such as A, B or C, is intended to mean A, B, or C, here used in the exclusive sense, as well as A, B and C.

Some portions of the detailed description which follow are presented in terms of algorithms or symbolic representations of operations on data bits or binary digital signals stored within a computing system, such as within a computer or computing system memory. These algorithmic descriptions or representations are the techniques used by those of ordinary skill in the data processing arts to convey the substance of their work to others skilled in the art. An algorithm is here, and generally, considered to be a self-consistent sequence of operations or similar processing leading to a desired result. The operations or processing may involve physical manipulations of physical quantities. Typically, although not necessarily, these quantities may take the form of electrical or magnetic signals capable of being stored, transferred, combined, compared or otherwise manipulated. It has proven convenient, at times, principally for reasons of common usage, to refer to these signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussions, it is appreciated that throughout this specification discussions utilizing terms such as “processing”, “computing”, “calculating”, “determining” or the like refer to the actions or processes of a computing platform, such as a computer or a similar electronic computing device, that manipulates or transfers data represented as physical electronic or magnetic quantities or other physical quantities within the computing platform's processors, memories, registers, or other information storage, transmission, or display devices.

Advertisements and advertising information as used and referred to herein may include any electronic content that provides information, enticement to inquire or make a purchase. The scope of coverage is not to be limited by the type, form, or format in which is it presented or stored.

A browser, or web browser, as used and referred to herein may be used interchangeably to include any software application which enables a user to gather, display and interact with electronic content. Commonly, a web browser provides a graphical representation of an environment that includes an address box and/or search box for data entry, and a browser window for display of electronic content.

Examples of electronic content include, but not limited to, text, images, videos, music, streaming content, and other information. Such electronic content may be located on a Web page at a website on the World Wide Web or a local area network. Text and images on a Web page may contain hyperlinks to other Web pages at the same or different website. Web browsers may allow a user to quickly and easily access information provided on many Web pages at many websites by traversing these hyperlinks.

Web browsers may communicate with Web servers using HTTP (hypertext transfer protocol) to fetch web pages, for example. Web pages may be located by means of a URL (uniform resource locator), which is treated as an address, for example.

A query, or content request, as used and referred to herein may be used interchangeably to include any mechanism that may be used to call or request electronic content using a web browser. By way of example, without limitation, a query may refer to text entered into a browser search box that may be used by a search engine to locate and display electronic content in the browser window; the electronic content displayed as a search results page, for example. By way of example, without limitation, a content request may refer to an address or URL entered into a browser address box, or a selection of a hyperlink, so as to call specific electronic content, such as a web page. The scope of coverage is not limited by the type, form, or format in which the query and content request is presented or stored.

A results page, or landing page, as used and referred to herein interchangeably is the electronic content displayed in a browser window. Electronic content may take a finite amount of time to be gathered, communicated, and displayed in the browser window after initiating a query or content request, for example. A fully loaded page as used and referred to herein is a results page or landing page that is displayed in the browser window having sufficient content associated therewith for a complete image available for viewing by a user. By way of example, a fully loaded page may be one where all of the text and/or images associated with a results page may be available to the user to read, select, or otherwise utilized.

It is understood that a results page may not only included static content, but also dynamic content. Dynamic content includes, by way of example, content that may be continuously updated in the browser window. For example, streaming content is dynamic content, that may include, for example, video, audio, and/or text that is continuously updated in the browser window. A fully loaded page as used and referred to herein also includes those pages wherein dynamic content is initiated for viewing on a display device.

In a variety of situations, such as, communicating over the Internet as only one example, that there may be a time delay between a content request made for example by a client device and display of the requested content on a display device of the client device. This may be especially pronounced in the presence of heavy Internet traffic or in attempts to access congested websites. Such a delay may be pronounced during Internet searches. As another example, without limitation, there may be a delay during an instant messaging session, such as between sending a message and receiving a message.

Claimed subject matter is not intended to be limited in scope to the embodiments provided herein; rather, such embodiments are provided merely for purposes of illustration without limitation. However, in one particular embodiment for example, targeted advertising may be displayed on a client device during a wait period between query or content request and display of the requested content. As further examples, without limitation, in particular embodiments, targeted advertising may be displayed during navigation, information, or transactional searches. For example, in one embodiment, targeted advertisements may remain displayed at least until a landing page of a content request has been fully loaded. Other embodiments in accordance with claimed subject matter are also described in more detail below.

In one embodiment, for example, targeted advertising may be displayed in a browser window on a client device, such as via a computer screen or other similar display device, for a client device having web browsing capability. In addition, targeted advertising may be displayed in other application environments present on a client device, such as a toolbar having an instant messenger application or the like.

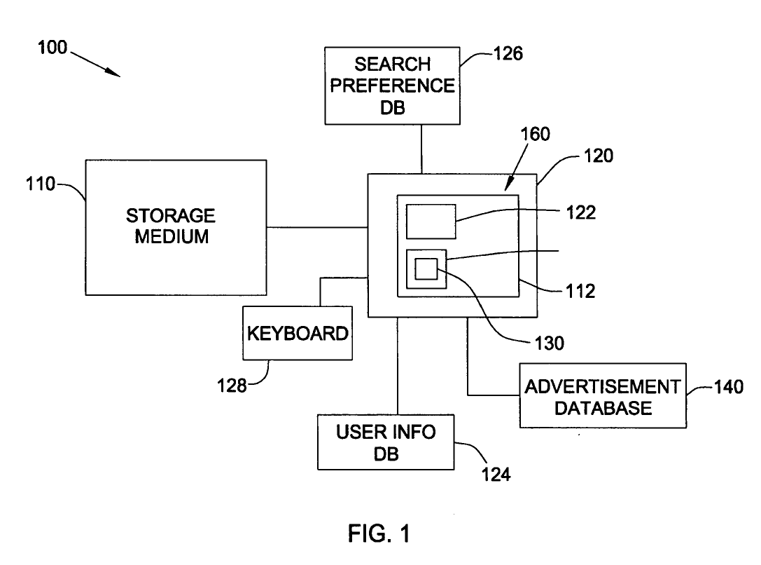

A client device may comprise any device, such as, but not limited to, computer, computing system, cellular phone, or similar electronic computing device, that is capable of manipulating or transforming data. An example embodiment 100 of a client device as shown schematically in FIG. 1. Embodiment 100 includes storage medium 110 coupled to computing platform 120. Computing platform 120 in this example is operable to display targeted advertising information 130 on display device 112. A content request may be made via an interface 122 accessible via display device 112. Received content, for example, may be displayed on display device 112 as landing page 132. As explained in more detail below, computing platform 120 may be operable to display targeted advertising information 130 on display device 112 during at least a portion of a period of time between a content request and display of the fully-loaded content as landing page 132.

For example, in this particular embodiment, although claimed subject matter is not limited in scope to this example, targeted advertising information 130 may be shown overlaid on landing page 132 as content is received by the client device. After such content has been fully received, such as a full web page to be displayed, as one example, targeted advertising information 130 is removed from the landing page 132. For example, display of the targeted advertising information 130 may take place in the browser window, although, again, claimed subject matter is not limited in scope to this particular example embodiment.

For this particular embodiment, targeted advertising information 130 may be provided to embodiment 100 via the Internet at the time of requesting content. As one example, a content request may comprise a search query relating to information that a search provider has already cached and stored on a server. As another example, a content request comprises a search query related to information not yet cached and stored. Although in the former case, a period of time between a content request and display of fully-loaded content as landing page 132 may be shorter than if the search results had not been cached and stored on a search server (uncached content). The difference in time between a content request and display of fully-loaded content for cached and uncached content is referred to as Δtime. Computing platform 120 is operable to add the Δtime to a time that the cached content would be fully-loaded, to calculate a maximum time that targeted advertising information may be displayed.

In yet another example embodiment 100, as illustrated in FIG. 1, further comprises advertisement database 140. Advertisement database 140 comprises computer readable storage that may include one or more advertisements that may be displayed as targeted advertising information 130, for example. Advertisement database 140 being integrated in embodiment 100 may provide reasonably rapid retrieval and display of targeted advertising information during at least a portion of a period of time between a content request and display of fully-loaded content, for example, as landing page 132. In one particular embodiment, for example, advertisement database 140 may be populated at the time of manufacture or assembly of computing platform 120. For example, pre-loaded advertisements may be employed so that a user may be reminded or exposed for the first time to particular products or services via the display of targeted advertising information 130.

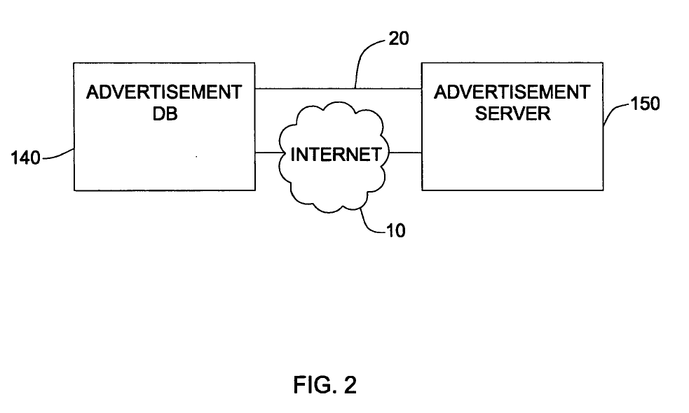

In another embodiment, advertisement database 140 may be populated with one or more advertisements at predetermined time intervals via the Internet. FIG. 2 illustrates an embodiment wherein advertisements may be available from a content provider. Examples of a content provider include, without limitation, a internet service provider and a web site. A plurality of advertisements may be made available for upload into advertisement database 140 from advertisement server 150 via a communication link 20, such as, but not limited to the Internet, for example, as shown schematically in FIG. 2, or by a wired or wireless telephonic uplink wherein the client device may be, for example, a cell phone, by way of another example. It is well understood that there are many methods for uploading data into storage media, and the examples provided herein are not intended to limit the scope of claimed subject matter in this regard. Previously loaded advertisements in advertisement database 140 may be replaced with other advertisements which may likewise be uploaded, although, again this is merely an example. The availability of uploadable advertisements may be provided by an external advertisement server 150, as describe above and illustrated schematically in FIG. 2.

Remotely populating database 140 with targeted advertising information, for example, may be desirable for a number of reasons. For example, a service provider making advertisements available on advertisement server 150 may be provided with a revenue stream based, at least in part, on advertisers purchasing advertisement placement on the advertisement server 150. Revenue generation may be based, for example, on a length of time an advertisement is made available on advertisement server 150. In another example, revenue generation may be based on a number of times a particular advertisement is uploaded to a client device. It is appreciated that these are only a few of a vast number of examples for revenue generation based on providing advertisements to a client device, and that presenting only these few examples is not to be construed to be limiting to the scope of the embodiments.

Advertisements that are contained in advertisement database 140 may be selected for display on display device 112 by any one or combination of selection criteria. For example, advertisements that are contained in advertisement database 140 may be selected for display without any prior knowledge of any particular user. Such advertisements may be less targeted to any specific user as will be made clearer in the discussion below. Advertisements may be selected for display simply based on an advertiser's willingness to pay for advertisement placement on a user client device, with the advertisement displayed in a controlled or random order. Such advertisements may be targeted to a client device user, in general, but may be less targeted to a specific user relative to more targeted embodiments provided below.

In yet another example, advertisements may be selected for display based on the content of a currently displayed web page. In yet another example, advertisements may be selected for display based on time and geographical location of the computing platform. In yet another example, advertisements may be selected for display based on the loaded page type, such as, but not limited to, video, text, and/or mixed media.

In yet another example, embodiment 100 as illustrated in FIG. 1 further comprises user information database 124. User information database 124 may be computer readable storage that may comprise user information such as, but not limited to, user name, age, location, occupation, or interests. Such user information may be provided to the user information database 124 by a user, or gathered from data stored elsewhere on the client device or elsewhere, for example, but not limited thereto. Computing platform 120 is operable to communicate with user information database 124. In an exemplary embodiment, selection of targeted advertising information 130 to be displayed may be based, at least in part, on user information contained in user information database 124. By way of example, where user information comprises a user's age within a defined range, targeted advertising information 130 may be selected by computing platform 120 based on those advertisements suitable for that particular age range. Advertisements may be selected from those advertisements preloaded in advertisement database 140 at the time of manufacture, or uploaded from advertisement server 150, as previously discussed.

In yet another example embodiment 100 as illustrated in FIG. 1, further comprises search preference database 126 in communication with computing platform 120. Search preference database 126 may comprise computer readable storage that may comprise search preference data determined from prior searches, websites visited or hyperlinks (URLs) clicked by a user, but not limited thereto. Such search preference data may be provided to search preference database 126 by computing platform 120 based on data, for example, a content request, but not limited thereto, entered via user interface 122 or keyboard 128, or any other suitable input device or method. Such search preference data may also be provided to the search preference database 126 by computing platform 120 based on the content received, for example, but not limited thereto.

Computing platform 120 may be operable to communicate with search preference database 126. In an exemplary embodiment, selection of targeted advertising information 130 to be displayed may be based, at least in part, on search preference data contained in search preference database 126. By way of example, where search preference data comprises a query regarding a Nissan automobile, and there is data regarding searches for Honda automobiles in search preference database 126, targeted advertising information 130 may be selected by computing platform 120 based, at least in part, on those advertisements related to automobiles.

It should be noted that a user's search preferences may be derived from a user's prior queries to a search engine as will be described below. In addition, search preferences may be derived from any website, search, or other action a user conducts online that may be stored on computing platform 120, and specifically search preference database 126, and analyzed by an application.

In yet another example embodiment 100 as illustrated in FIG. 1, computing platform 120 is operable to communicate with user information database 124 and search preference database 126. In an exemplary embodiment, the selection of targeted advertising information 130 to be displayed may be based, at least in part, on user information contained in user information database 124 as well as search preference data contained in search preference database 126. By way of example, not limited thereto, user information may comprise the age of a user. Search preference data may comprise data regarding searches for Honda automobiles in search preference database 126. Targeted advertising information 130 may be selected by computing platform 120 based, at least in part, on those advertisements related to Honda motorcycles that may appeal to the respective age.

Referring again to FIG. 1, computing platform 120 of embodiment 100 further comprises toolbar-based application 160, a part of which includes user interface 122. Toolbar-based application 160 may be operable to record online activities of a user and communicate those activities as search preference data to the search preference database 126. Toolbar-based application 160 may further be operable to select an advertisement from advertisement database 140 for display of the selected advertisement during at least a portion of a period of time between a content request and the display of the fully-loaded content as landing page 132

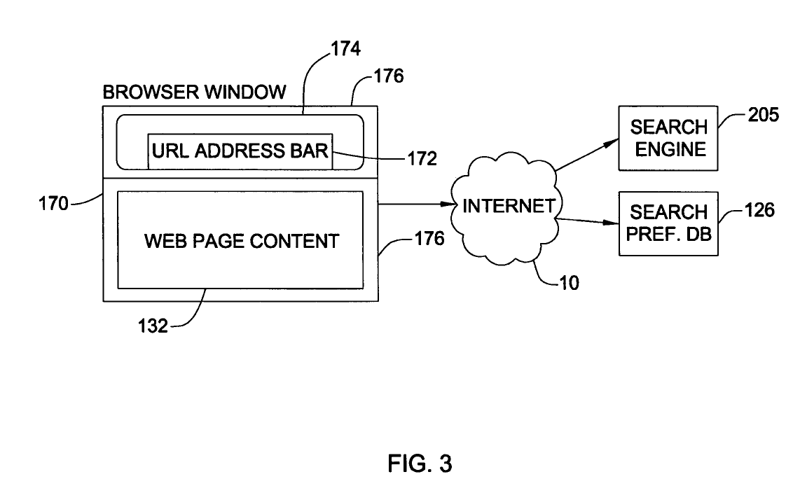

An exemplary embodiment of a layout of browser window 170 as shown schematically in FIG. 3. Browser window 170 is the graphic display of a browser application. Browser applications are well known to those in the art and details of which will not be provided herein. Browser window 170 comprises toolbar 174 which may be an interface to toolbar-based application 160 described above in FIG. 1. Toolbar 174 includes web search engine interface 172, for example, a URL address bar or keyword search bar, but not limited thereto. Toolbar 174 is operable to communicate with search engine 205. If a user inputs one or more search terms into search engine interface 172, search engine interface 172 may communicate search terms to search engine 205, as well as to search preference database 126 for storage. Search engine 205 performs a search of the Internet and displays search results on browser window 170. Browser window 170 may display one or more targeted advertisements, based on input search terms, during at least a portion of a period of time between a query and the display of the fully-loaded query results as landing page 132.

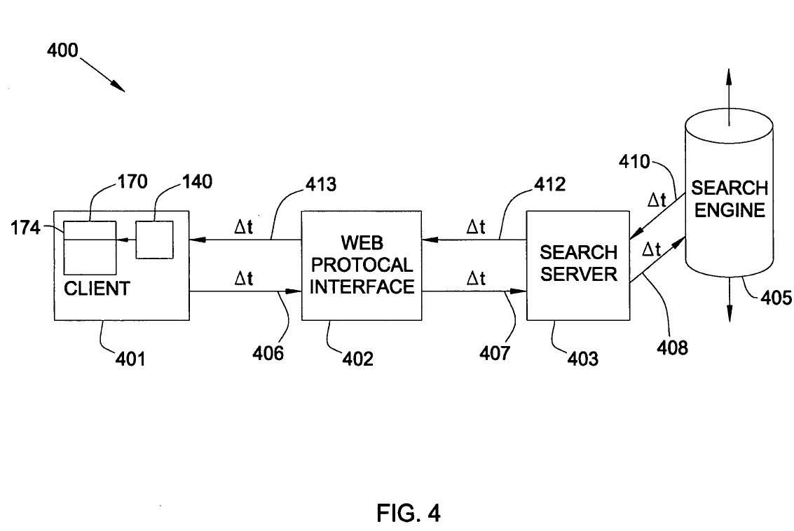

FIG. 4 is a schematic diagram of an exemplary embodiment 400 of an Internet search system. In FIG. 4, client 401, execution of toolbar 174 of browser 170 initiates transmission of search query on path 406, 407 to search server 403 through web protocol interface 402. Search server 403 and web protocol interface 402 may be remote from client 401 or integral with client 401. Web protocol interface 402 may be implemented by means of a web server operable to receive, for example, keyword search requests from clients. Search server 403 performs a search of Internet content by accessing search engine 405, sending the query along path 408. Search engine 405 may be one of well-known search engines available on the Internet, including, without limitation, Yahoo, Google, MSN, or Alta Vista. Search engine 405 stores and indexes a plurality of search results in storage, also known as cached search results.

After executing the query, search engine 405 returns query results to search server 403 along path 410. Client 401 receives the query results from search server 403 through web protocol interface 402, along path 412, 413. Query results are sent to browser window 170 for display.

The search query and query results take a finite amount of time, Δt, to travel path 406, 407, 408, 410, 412, 413. Δt may further include time for the search query and query results to be executed by the web protocol interface 402, search server 403, search engine 405, and any other application that contributes to at least a portion of a period of time between a search query and the display of the fully-loaded query results on the browser window 170.

Client 401 comprises advertisement database 140 as described above. Browser 170 is operable to display targeted advertising information obtained from advertisement database 140 for at least a portion of a period of time Δt.

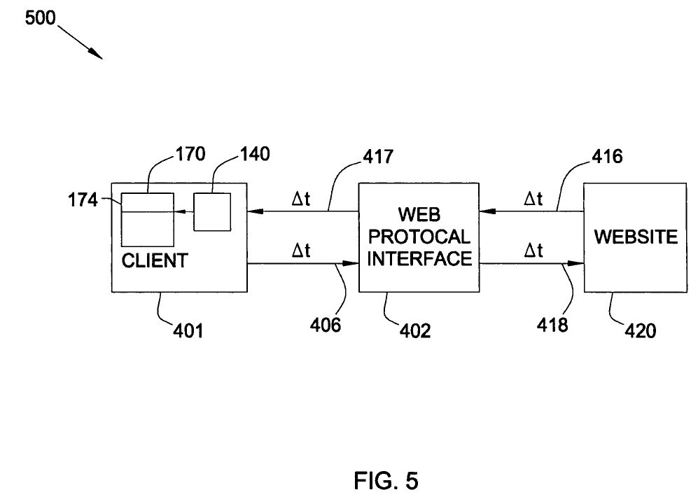

FIG. 5 is a schematic diagram of another exemplary embodiment 500 of an Internet search system. Embodiment 500 comprises some of the same common elements of embodiment 400 shown in FIG. 4. Client 401, through execution of toolbar 174, may transmit an HTML request on path 406, 418 to target website 420 through web protocol interface 402. Again, web protocol interface 402 may be remote from client 401 or integral with client 401. Web protocol interface 404 may be implemented by means of a web server operable to receive, for example, HTTP requests from clients. After the HTML request reaches website 420, website 420 may transmit a webpage on path 416 and 417 to be displayed by browser 170, as landing page 132 as shown in FIG. 3, for example.

The HTML request and resulting webpage take a finite amount of time, Δt, to travel path 406, 418, 416, 417. Δt may further include time for the html request to be executed by the web protocol interface 402 and target website 420, and any other application that contributes to at least a portion of a period of time between an HTML request and the display of the fully-loaded landing page on browser 170. Browser 170 is operable to display targeted advertising information obtained from advertisement database 140 for at least a portion of a period of time Δt.

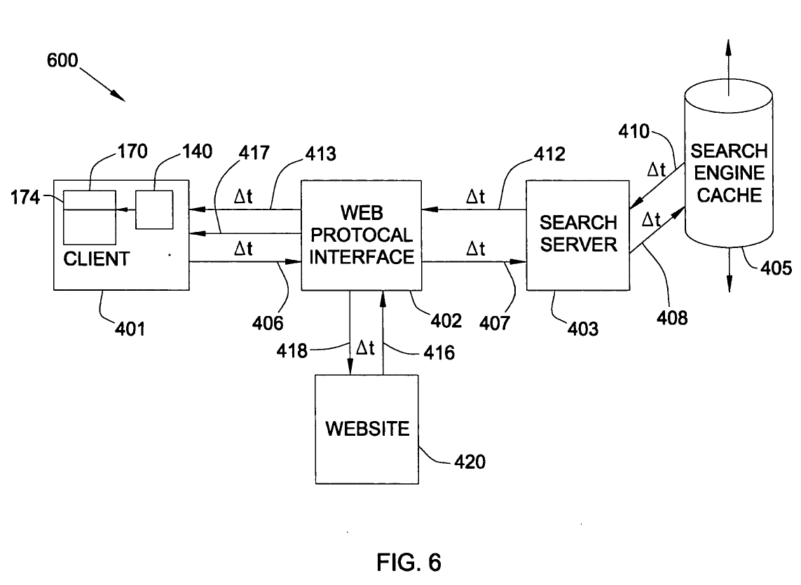

FIG. 6 is a schematic diagram of another exemplary embodiment 600 of an Internet search system. Embodiment 600 comprises the same elements of embodiment 400 shown in FIG. 4, and the same elements of embodiment 500 shown in FIG. 5. In embodiment 600, an HTML request can take any one of two paths, each resulting in display of landing page 132 on browser 170. Along first path 406, 407, 408, 410, 412, 413, landing page 132 is retrieved from cache from search engine 405. Along second path 406, 418, 416, 417, landing page 132 is retrieved from target website 420. First path 406, 407, 408, 410, 412, 413 may have a corresponding first Δt that is less than a second Δt corresponding to second path 406, 418, 416, 417. Each first and second Δt may further include time for the html request to be executed by other elements in the paths. Browser 170 may be operable to display targeted advertising information 130 obtained from advertisement database 140 for at least a portion of a period of time of the larger Δt between an HTML request and the display of the fully-loaded landing page on browser 170.

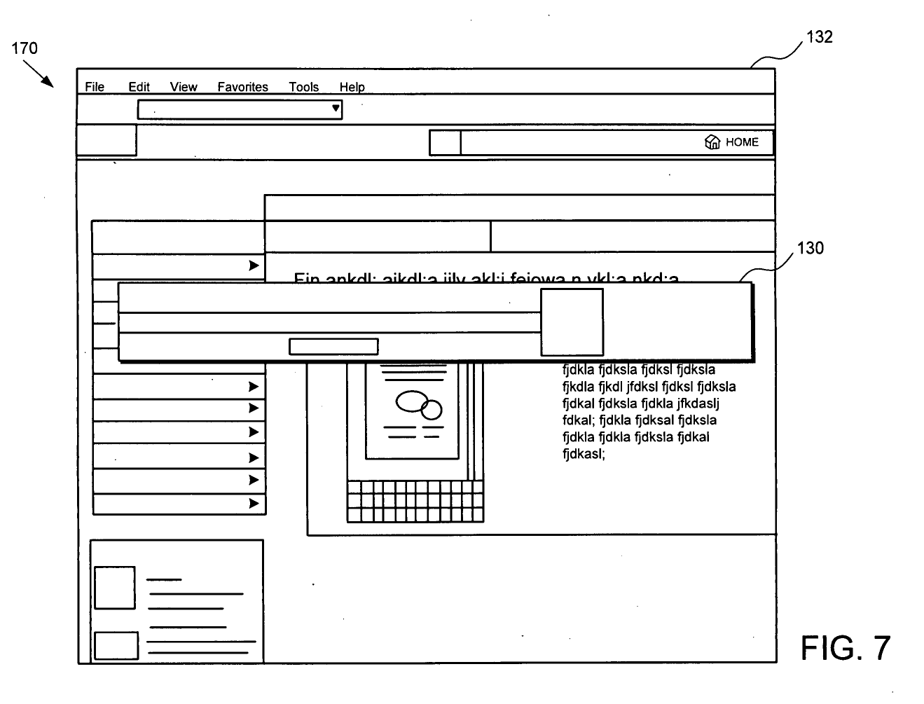

An exemplary embodiment of browser window 170 comprising partially-loaded landing page 132 overlaid with targeted advertising information 130 is depicted in FIG. 7. The image presented may be a result of an HTML request with landing page 132 being a resulting webpage. In the instant embodiment, partially-loaded landing page 132, in this instance a webpage from CNBC, is shown on the browser as a faded image so as to indicate to a user that, among other things, the delay in presenting the landing page 132 is legitimate and that the display of targeted advertising information 130, in this case an Infinity advertisement, is not encroaching on a fully-loaded landing page 132. A user may see landing page 132 rendering in the background as it is being received by the client device. The partially-loaded landing page 132 may be presented in a faded rendering so as to not substantially diminish the impact of targeted advertising information 130. Targeted advertising information 130 disappears upon completion of loading of landing page 132.

In an embodiment, after targeted advertising information 130 has disappeared, the toolbar may comprise a link to previously displayed targeted advertising information 130 such that the use may inquire further.

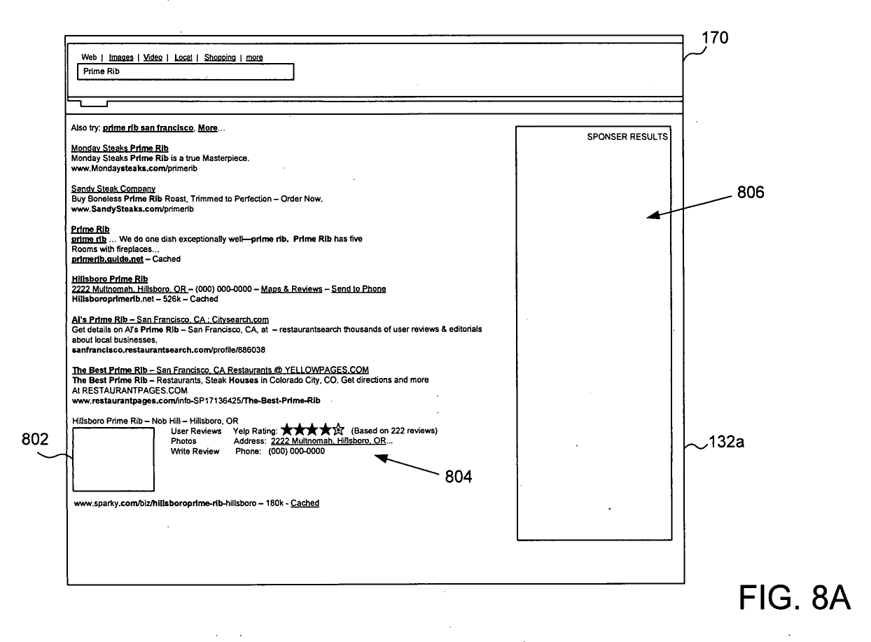

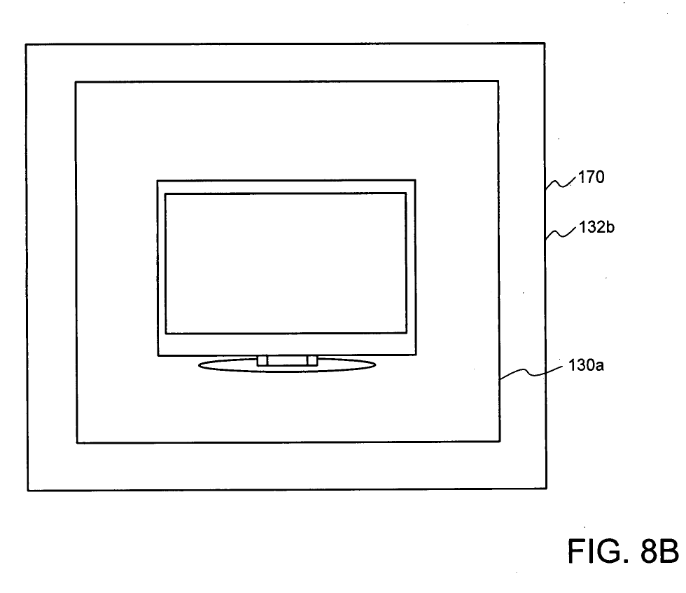

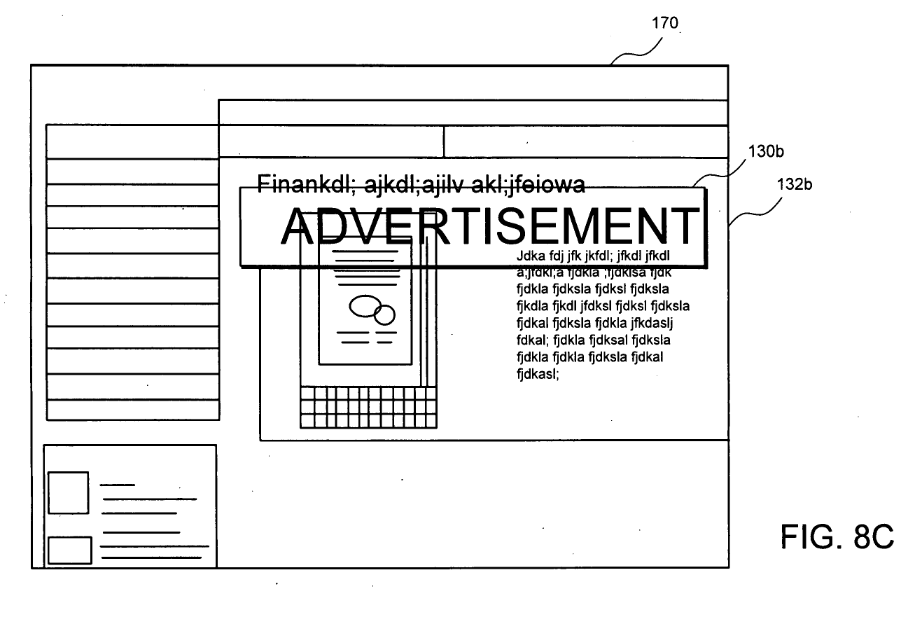

FIG. 8A depicts an embodiment of landing page 132a shown on a web browser window as a search results page on a popular search engine YAHOO!. The search results displayed are the result of a search using keywords “house of prime rib”. Landing page 132a a plurality of options for requesting further content. Sponsored links 806 are prominently displayed to the left of browser window 170 which may be selected by a user. Sponsored links 806 are an example of a sponsored result or link, which may be retrieved by a search system from a paid advertisements database and inserted into a results page. A user may use this link to access an advertiser website. In an embodiment of a model for generating revenue, sponsored links 806 may generate revenue for the search engine provider in exchange for placing the sponsored links 806 in a dominant position of browser window 170. Since sponsored links 806 already generate revenue, selecting one of the sponsored links 806 will display the resulting landing page without the intervening display of targeted advertising information 130.

Search results are presented in browser window 170 as depicted in FIG. 8A. The depicted search result page includes “free” search results in the form of image links 802 and hypertext links 804, which may have been retrieved from the web. These results are also referred to as “free” search results because they are not sponsored or paid for by an advertiser.

Image link 802 may be selected to present a landing page associated with image link 802. As depicted in FIG. 8B, in an embodiment of another model for generating revenue, selecting image link 802 results in the display of targeted advertisement information 130a during at least a portion of a period of time between selecting image link 804 and the display of fully-loaded landing page 132. As depicted in FIG. 8B, browser window 170 displays partially-loaded landing page 132b overlaid with targeted advertising information 130a.

Referring again to FIG. 8A, hypertext link 804 may be selected to present a landing page associated with hypertext link 804. As depicted in FIG. 8C, in an embodiment of another model for generating revenue, selecting the hypertext link 804 results in the display of targeted advertisement information 130 during at least a portion of a period of time between selecting the hypertext link 804 and the display of the fully-loaded landing page 132. As depicted in FIG. 8C, browser window 170 displays partially-loaded landing page 132b overlaid with targeted advertising information 130b.

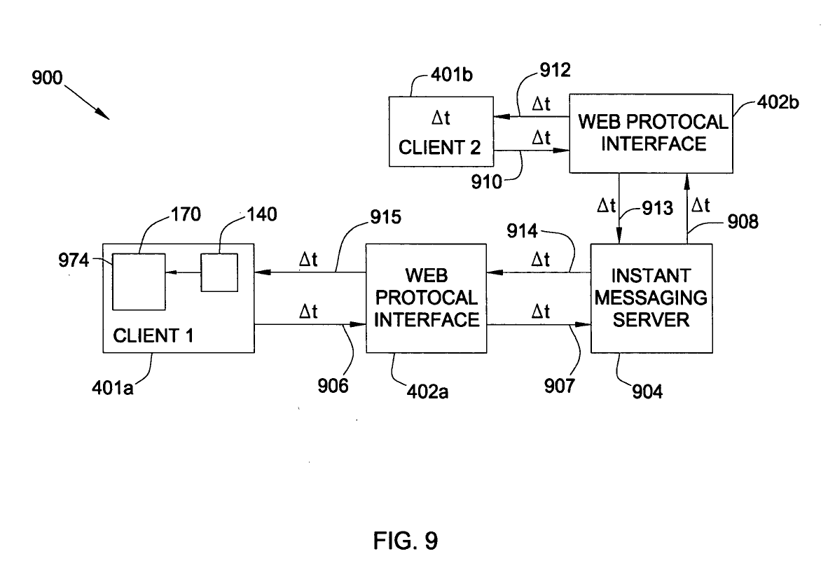

A toolbar may further include capability for users to exchange information, the ability to meet new people, or conduct social networking activities in their computer browser. FIG. 9 is a schematic diagram of an exemplary embodiment 900 of an Internet instant messaging system. In FIG. 9, first client 401a, through execution of toolbar 174 comprising instant messaging functionality, may transmit message on path 906, 907 to instant messaging server 904 through a first web protocol interface 402a. Web protocol interface 402a may be remote from client 901a or integral with client 901a. Web protocol interface 402a may be implemented by means of a web server operable to send and receive instant messages from clients. Instant massaging server 904 may be one of well-known instant messaging servers available on the Internet, including, without limitation, Yahoo! Messenger, Windows Live Messenger, AOL Instant Messenger, or Google Talk.

Instant messaging server 904 sends the message on path 908, 910 to a second client 401b through a second web protocol interface 402b. Likewise, second client 401b sends a message on path 912, 913, 914, 915 to first client 401A. The sending and receiving of instant messages takes a finite amount of time, Δt, to travel path 906, 907, 908, 910, 912, 913 914, 915. Δt may further include time for the outgoing and incoming message to be executed by the web protocol interface 402a, 402b, instant messaging server 904, and any other application that contributes to at least a portion of a period of time between sending a message and receiving a message on the toolbar 174.

Client 401 comprises advertisement database 140 as described above. Toolbar 174 is operable to display targeted advertising information obtained from advertisement database 140 for at least a portion of a period of Δt.

The exact mechanism for reimbursement or payment to have advertisements displayed is not essential to the present embodiments. For example, payment for advertising may be by just the fact it gets displayed periodically on a client device. In another example, payment for advertisement may have a click-through payment system if a user clicks an advertisement for inquiry. For example, but not limited thereto, while targeted advertising information 130 is being displayed, a user may click through the targeted advertising information 130 for inquiry.

It will be appreciated by those of skill in the art that embodiments described herein are not limited to interoperating with only one advertiser or only one external search engine. In an embodiment of a search system, a user may specify which external search engine should be used to retrieve a web search results.

In an embodiment the entire process of displaying a targeted advertisement may occur locally on a client device.

Advertisements/information/content may be retrieved based not only on search keywords input by a user, but also based on personal preferences, interests and demographics of a user, collected and stored on a client device. The embodiments enable each user to receive very targeted, localized and personalized advertising information. The collected personalized data of a user may be stored on a user's client device by computing platform 120.

It should be noted that toolbar as well as other applications may be used in conjunction with any browser application installed on any computing platform, including, without limitation, Internet Explorer, Firefox, Netscape, etc. for either PC or MAC computers. Toolbar described herein may be a proprietary toolbar or, in the alternative, software can be incorporated into any existing toolbar, including, without limitation, Yahoo, Google, and MSN toolbars.

When a user inputs a request for a webpage into a URL address field of a browser or sends a search query to a search engine, toolbar intercepts user's request and forwards it to an application. Computer-implemented method analyzes a user-specified URL or a search request, as well as information on user's interests, which may be based on user's prior online activities stored on a client device in a database structure or the like. If user's prior activities associated with a new request are found, the most frequently used activity may be returned and its priority may be incremented. This data may be then used to retrieve targeted advertising information.

The information on a user's preferences may be subsequently added by the system to a computing platform to a search engine, such that computing platform uses the added preference information to select which targeted advertisement to display. For example, if a user searches for cars, computing platform determines which of advertisements to display.

The user information may be used to display more relevant ads in a toolbar to display information, content, or advertising more relevantly and customized for each user.

It should be noted that the present embodiments are not limited solely to inclusion of user preference information into a search engine query. Such information may also be included with user's request for any network resource, including requests for specific internet resources, such as web pages, advertisements, commercials, local and national online newspapers, video/music, online TV, online radio or other Internet content.

In an embodiment of methodology, if an Internet user connects to the Internet and begins to browse web pages, a computer-implemented method may automatically analyze and store on a client device information, links, searches, and websites. At any point in time when a user conducts a search or when advertisings are displayed to a user in response to user's requests for Internet resource, additional information related to a user may be added to a database. The toolbar, in turn, may respond by providing relevant targeted advertising information to a user.

An aspect of embodiments of the methodology enables advertisers to display their advertisings independent on whether the advertiser may be affiliated with a webpage. A toolbar executing in conjunction with a web browser may display targeted advertisements related to content to be displayed on the main browser page. Specifically, every time a webpage may be requested by a user running the toolbar, toolbar displays advertising on every page viewed, as long as there may be a delay between a request for content and receive the requested content. Toolbar may display relevant targeted advertisements on all websites that the user visits. Toolbar selects the advertisements for display based on displayed content as well as, or instead of, preferences of a user.

Exemplary embodiments of search engines which are well known in the art include, without limitation, Yahoo, Google, Alta Vista, etc. The search engine may use its own technology to return the local search results to clients, based on the location feed from the system through a modified query.

It will, of course, be understood that, although particular embodiments have just been described, claimed subject matter is not limited in scope to a particular embodiment or implementation. For example, one embodiment may be in hardware, such as implemented to operate as part of a system or with a combination of devices, for example, whereas another embodiment may be implemented to operate in conjunction with or as part of any combination of hardware, software or firmware, for example. Likewise, although claimed subject matter is not limited in scope in this respect, one embodiment may also include one or more articles, such as a storage medium or storage media. As another potential example, an embodiment may be implemented with or as part of a computing platform, which may include one or more processing units or processors, one or more input/output devices, such as a display, a keyboard or a mouse, or one or more memories, such as static random access memory, dynamic random access memory, flash memory, or a hard drive. It may be also worth noting that embodiments of claimed subject matter may be employed in a variety of contexts. Thus, claimed subject matter is not limited to implementation in an information handling system. Again, as previously indicated, many other approaches to implementation via software, firmware or hardware are included within the scope of claimed subject matter.

In the preceding description, various aspects of claimed subject matter have been described. For purposes of explanation, specific numbers, systems or configurations were set forth to provide a thorough understanding of claimed subject matter. However, it should be apparent to one skilled in the art having the benefit of this disclosure that claimed subject matter may be practiced without the specific details. In other instances, well-known features were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

What is claimed is:

1. A method comprising:
receiving a content request from a computing platform; and
initiating display of targeted advertising information in response to said content request during at least a portion of a period of time between receiving a content request until content of said content request is fully loaded to said computing platform as a fully loaded result.

2. The method of claim 1, further comprising:
initiating the termination of the displaying of the targeted advertising information upon display of the fully loaded result.

3. The method of claim 1, wherein said content request is received as a query to a web search engine from a user interface.

4. The method of claim 1, further comprising:
receiving said content request as a selection initiating a site URL;
initiating display of said fully loaded result of the content request as a results page based on the selected site URL; and
initiating display of the targeted advertising information during at least a portion of the period between selection of said URL and display of a fully loaded results page.

5. The method of claim 3, wherein said initiating the targeted advertising information comprises:
initiating display of the targeted advertising information as a semitransparent window over at least a portion of the fully loaded result.

6. The method of claim 1, further comprising:
calculating a web latency time for page loading for a predetermined website, wherein the period of time of displaying said targeted advertising information is based, at least in part, on the calculated web latency time.

7. The method of claim 3, further comprising:
enabling a user to send a response and receive a result in the form of initiating contact with other users, exchanging information with other users or conducting social networking activities with other users, wherein initiating display comprises:
initiating display of said targeted advertising information during at least a portion of a period of time between sending a response and receiving a fully loaded result.

8. An article comprising: a storage medium having stored thereon instructions that, if executed, enable a computing platform to:
receive a content request from a computing platform; and
initiate display of targeted advertising information in response to said content request during at least a portion of a period of time between receiving a content request until content of said content request is fully loaded to said computing platform as a fully loaded result.

9. The article of claim 8, wherein said instructions, if executed, further enable the computing platform to:
initiate the termination of the displaying of the targeted advertising information upon display of the fully loaded result.

10. The article of claim 8, wherein said content request is received as a query to a web search engine from a user interface.

11. The article of claim 8, wherein said instructions, if executed, further enable the computing platform to:
receive said content request as a selection initiating a site URL;
display of said fully loaded result of the content request as a results page based on the selected site URL; and
initiate display of the targeted advertising information during at least a portion of the period between selection of said URL and display of a fully loaded results page.

12. The article of claim 11, wherein said instructions, if executed, further enable the computing platform to:
initiate display of the targeted advertising information as a semitransparent window over at least a portion of the fully loaded result.

13. The article of claim 8, wherein said instructions, if executed, further enable the computing platform to:
calculate a web latency time for page loading for a predetermined website, wherein the period of time of displaying said targeted advertising information is based, at least in part, on the calculated web latency time.

14. The article of claim 11, wherein said instructions, if executed, further enable the computing platform to:
enable a user to send a response and receive a result in the form of initiating contact with other users, exchanging information with other users or conducting social networking activities with other users, wherein initiating display comprises:
initiate display of said targeted advertising information during at least a portion of a period of time between sending a response and receiving a fully loaded result.

15. An apparatus comprising:
a computing platform; wherein said computing platform operable to:
receive a content request from a computing platform;
initiate display of targeted advertising information in response to said content request during at least a portion of a period of time between receiving a content request until content of said content request is fully loaded to said computing platform as a fully loaded result, and
initiate the termination of the displaying of the targeted advertising information upon display of the fully loaded result.

16. The apparatus of claim 15, wherein said content request is received as a query to a web search engine from a user interface.

17. The apparatus of claim 15, wherein said computing platform further operable to:
receive said content request as a selection initiating a site URL;
display of said fully loaded result of the content request as a results page based on the selected site URL; and
initiate of display the targeted advertising information during at least a portion of the period between selection of said URL and display of a fully loaded results page.

18. The apparatus of claim 15, wherein said computing platform further operable to:
initiate of display the targeted advertising information as a semitransparent window over at least a portion of the fully loaded result.

19. The apparatus of claim 15, wherein said computing platform further operable to:
calculate a web latency time for page loading for a predetermined website, wherein the period of time of displaying said targeted advertising information is based, at least in part, on the calculated web latency time.

20. The apparatus of claim 15, wherein said computing platform further operable to:
enable a user to send a response and receive a result in the form of initiating contact with other users, exchanging information with other users or conducting social networking activities with other users, wherein initiating display comprises:
initiate display of said targeted advertising information during at least a portion of a period of time between sending a response and receiving the fully loaded result.
